(19) United States
(12) Patent Application Publication
(10) Pub. No.: US 2004/0123899 A1
(43) Pub. Date: Jul. 1, 2004

(54) Dry break disconnect

(75) Inventor: James Turvey, Costa Mesa, CA (US)

Correspondence Address: FAY, SHARPE, FAGAN,, MINNICH & McKEE, LLP, 7th Floor, 1100 Superior Avenue, Cleveland, OH, 44114-2516, US

(73) Assignee: Argo-Tech Corporation Costa Mesa

(21) Appl. No.: 10/668,040

(22) Filed: Sep. 22, 2003

Related U.S. Application Data
(60) Provisional application No. 60/412,175, filed on Sep. 20, 2002.

(51) Int. Cl. F16K 17/40

(52) U.S. Cl. 137/68.15

(57) ABSTRACT

A dry break disconnect and process provides a frangible connection in the fuel line to prevent damage in case of a drive away event. Frangible connecters such as rivets are intended to shear at a predetermined force to separate upstream and downstream body portions of the disconnect assembly and thereby actuate upstream and downstream poppet members to seal and prevent further spillage of fuel.

This application claims the priority benefit of U.S. provisional application Serial No. 60/412,175, filed Sep. 20, 2003, the details of which are incorporated by reference herein.

### BACKGROUND OF THE INVENTION

This invention generally relates to liquid natural gas (LNG) delivery systems and, more particularly, to a disconnect assembly particularly suited for use with a filling line or hose, for example, associated with an LNG fuel delivery system.

Recent years have seen a substantial increase in the use of vehicles powered by alternative fuel sources. One such fuel source is natural gas since it is plentiful in supply and its byproducts when used as a fuel source for vehicles have a reduced environmental impact than gasoline, diesel fuel, or similar oil-based fuels.

One significant area of LNG fuel use is associated with large vehicles such as mass transit vehicles including buses, municipal vehicles, automotive fleets, etc. As such, these vehicles are often filled at a central filling site, although it is believed that increased use will develop additional fueling stations in the consumer market as well. These alternative fuel vehicles take an extended period of time to fill the onboard fuel tank. Typically, a storage vessel having a large supply of LNG has one or more delivery lines extending therefrom. That is, each delivery line or hose is connected at one end to the bulk supply storage vessel (or a manifold), and includes a dispensing nozzle at the other end that cooperates with a mating receptacle provided on the vehicle. The nozzle and receptacle often include automated valves such as poppet valves as are commonly used in the LNG industry so that when disconnected, each of the poppets in the nozzle and receptacle (male and female components of the coupling assembly) are closed. For example, commonly owned U.S. Pat. No. 5,429,155 discloses a cryogenic fluid coupling that generally teaches male and female coupling components that incorporate poppet-type check valves to close each coupling half when the components are separated, and the poppets are moved away from their respective valve seats once the coupling is complete to establish flow therethrough.

Although the automatic valves have proven effective to prevent fuel leakage from the fuel line and the receptacle, a need exists for an inexpensive, effective manner of providing a disconnect if the fill line is connected to the vehicle and the vehicle operator inadvertently attempts to drive away. One proposed solution to this problem in the industry is to provide a lockout on the vehicle. For example, one type of lockout employs a sensor associated with a pivoting fuel access door that covers the fuel receptacle on the vehicle. For example, a proximity sensor detects when the fuel door is open during the refueling process. A signal is then sent to the starter or transmission to prevent the vehicle from being started or, alternatively, prevent the vehicle from being shifted into gear. When the fuel door is closed, the lockout signal is terminated and the operator is free to either start the vehicle or place it in gear. As will be appreciated, each vehicle of the fleet must be modified (i.e., incorporate a lockout feature) to effectively address the inadvertent driveaway situation with this type of solution. Moreover, expensive wiring is necessary to provide such an arrangement as original equipment or as a retrofit to existing vehicle fleets. Thus, this solution is believed to encounter additional and unnecessary costs.

In addition, the central fillings sites locate different fuel sources and their associated fuel lines (e.g., gasoline, diesel fuel, LNG) adjacent one another, or the fuel lines extend from a common gantry. Thus, if a driveway event occurs, other fuel delivery services may be adversely interrupted.

An effective, more economical solution is desired.

### SUMMARY OF THE INVENTION

The present invention contemplates a dry break disconnect assembly in a fuel line between a fuel storage reservoir and a nozzle end of the line.

In accordance with an exemplary embodiment of the invention, the dry break disconnect assembly includes a frangible connection that allows the fuel line to break away, i.e., disconnect, if an operator inadvertently drives away with the fuel nozzle inserted in the receptacle of the vehicle.

The dry break disconnect assembly preferably includes first and second check valves disposed upstream and downstream of the frangible connection region of the fuel line to shut off flow if the disconnect is actuated.

The disconnect assembly may be secured with predetermined slack that is initially removed from the fuel line before the frangible connection of the disconnect is actuated, or that serves to limit tensile forces associated with a driveaway event from reaching the interconnection of the fuel line with the storage tank or manifold.

A method of limiting potential damage associated with inadvertent drive-away of a vehicle during refueling is also contemplated. The process includes the steps of inserting a breakaway or frangible connection into the fuel line. At a predetermined force, the frangible connection is broken.

The process includes the further steps of providing upstream and downstream check valves on either side of the frangible connection.

In a preferred arrangement, the dry break disconnect includes mirrored components for ease of manufacture and assembly.

A primary advantage of the present invention is an effective process and apparatus for addressing inadvertent driveaway events during refueling of a vehicle.

Another advantage of the invention resides in the ease with which the invention is provided as original equipment or retrofit into existing equipment.

Still another advantage of the invention is provided in the ability to address the disconnect need at the fill line rather than in each individual vehicle.

Yet another advantage is found in the ease with which a dry break disconnect assembly can be replaced if the frangible connection is broken.

Still other advantages and benefits of the invention will become apparent to those skilled in the art upon reading and understanding the following detailed description.

### BRIEF DESCRIPTION OF THE DRAWINGS

FIG. 1 is a schematic representation of a vehicle at a refueling station such as a LNG refueling system.

FIG. 2 is a perspective view of a dry break disconnect.

FIG. 3 is an end view thereof.

FIG. 4 is a cross-sectional view taken generally along lines 4-4 of FIG. 3.

### DETAILED DESCRIPTION OF THE INVENTION

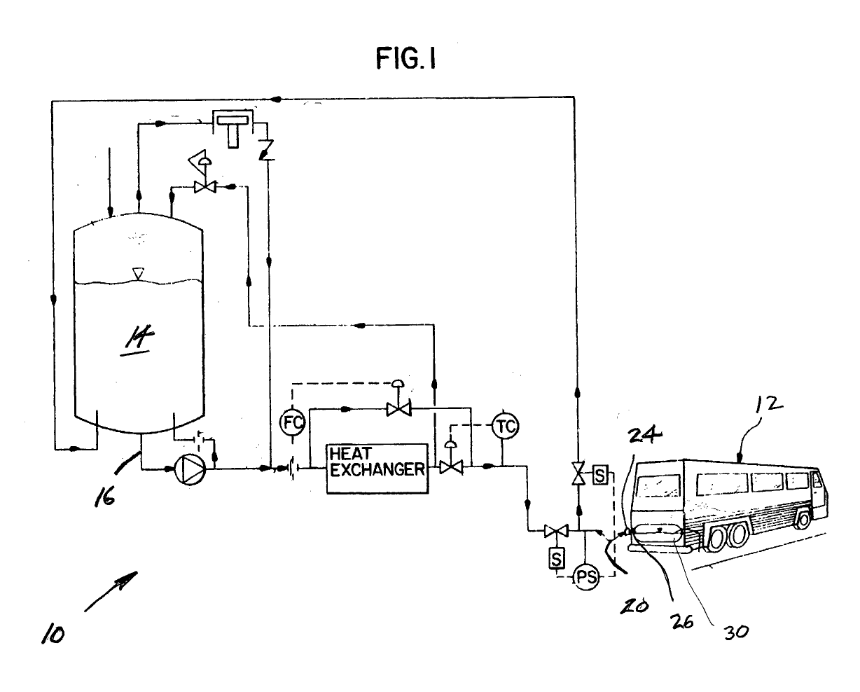

FIG. 1 is a schematic representation of a fueling system 10 associated with one or more vehicles 12. For example, such a system is shown and described in U.S. Pat. No. 5,687,776. It will be appreciated, however, that this is merely representative of one type of fueling system, for example, as associated with storing and dispensing liquefied cryogenic fuel such as LNG, methane, ethane, ethylene, or hydrogen as fuel for vehicles of all types. The fueling system 10 includes a storage reservoir or primary storage tank 14 that stores a large quantity of the fuel used in the fuel system. Conduits or lines extend to and from the tank and are used in association with a pump, valves, heat exchangers, etc. to deliver fuel to the fuel line or hose 20. The fuel hose is thus a conduit or line that has a first end associated with the reservoir 14 (or a manifold if multiple fuel lines are used) and a second end 24 that terminates in a conventional fuel delivery nozzle for mating receipt in a receptacle 26 mounted on the vehicle. The receptacle communicates with fuel tank 30 on board the vehicle so that a predetermined quantity of fuel can be stored as needed. As will be appreciated, the fuel tank 30 is periodically replenished at the fueling system 10 in a manner generally known in the art.

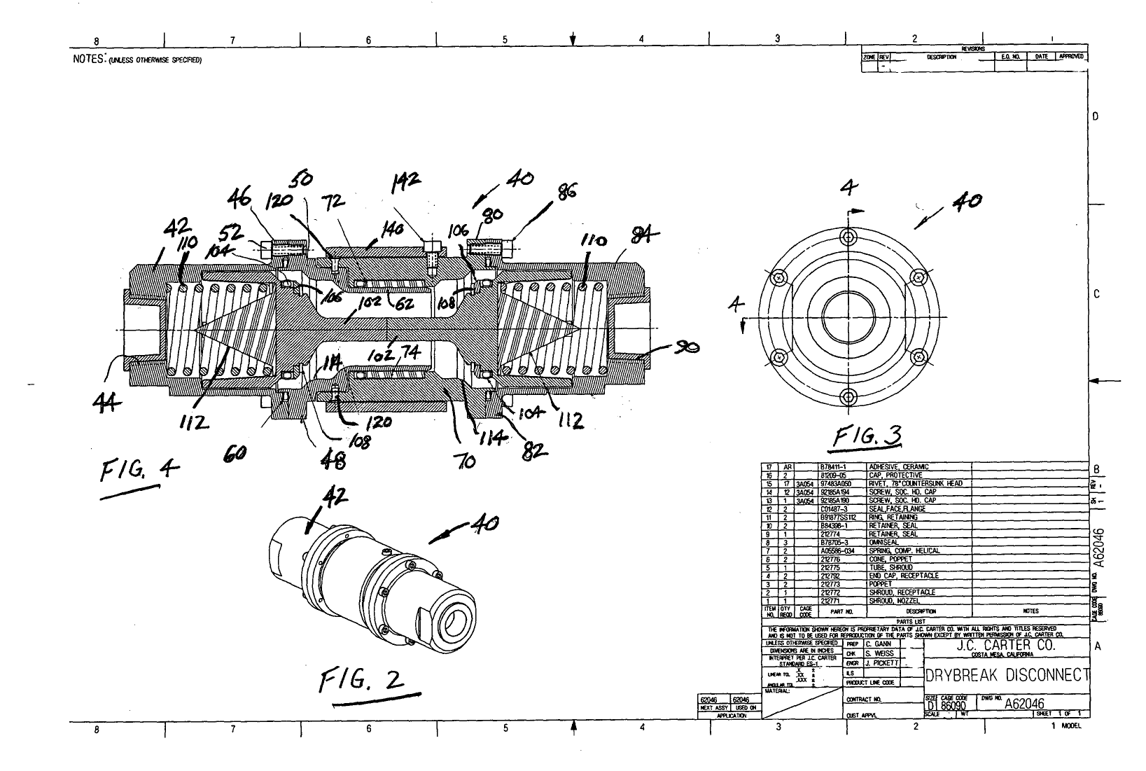

In accordance with the present invention, the fuel line or hose 20 is modified. Particularly, a dry break disconnect assembly 40 (FIGS. 2-4) is incorporated into the fuel line. A first member or end cap 42 communicates with the fuel line, preferably via a coupling such as internal threads 44 of a standard NPT type fitting. A first or inner end of the end cap terminates in an enlarged shoulder or flange 46 that abuts against a like shoulder or flange 48 of a receptacle shroud body 50. Fasteners 52 secure the end cap and nozzle body together and a seal, such as flange face seal 60, is interposed axially between the facing flanges of the body and end cap and located radially inward of the circumferentially spaced fasteners to provide a suitable sealed interface between these components. The receptacle shroud body includes a reduced diameter portion 62 that is axially received within a nozzle shroud body 70. A suitable seal 72 is radially interposed between the receptacle shroud body and the nozzle shroud body, and a retaining sleeve 74 holds the seal in place. Any suitable seal, for example one that is effective at cryogenic delivery temperatures associated with LNG fuel can be used. Thus it will be appreciated that in other fuel delivery systems, different type seals can be used with equal success. The present invention should not be limited to the particular fuel or types of materials compatible therewith. The nozzle shroud body terminates at its other end in a radial shoulder or flange 80 that abuts with a like-dimensioned shoulder or flange 82 and a second member or downstream end cap body 84. Again, a suitable seal such as flange face seal 86 is interposed between these components and fasteners such as fastener screws 88 hold the components in a sealed, secure relationship. Internal threads 90 at the terminal end of the second end cap are also adapted to provide a conventional connection, such as an NPT threaded arrangement, with a downstream portion of the fuel line that terminates in the fuel delivery nozzle (not shown). That nozzle is then received in an associated mating receptacle on the vehicle.

Each end cap and shroud body carries a check valve or poppet member 100, and description of one is fully applicable to the other unless specifically noted otherwise. The poppet assembly preferably includes a stem 102 that merges into a radially enlarged portion that carries poppet seal member 104. The poppet seal member is held in place by a seal retainer 106 and a retaining ring 108. The poppet is urged toward a closed position by urging member or coil spring 110 that extends around poppet cone 112. The poppet is urged toward engagement with valve seat 114.

In the assembled arrangement illustrated in FIG. 4, the shroud bodies are maintained in mating relation by a series of circumferentially spaced frangible connectors 120, shown here as individual rivets that extend and interconnect the shroud bodies in a radial direction. The rivets 120 may be circumferentially spaced and of a predetermined size so as to break or shear in response to a force such as an axial or tensile force imposed on the disconnect assembly 40. Of course, one such tensile force would be associated with a vehicle that inadvertently attempts to drive away while the fuel nozzle is still in the receptacle. Any slack in the fuel line would be initially removed and any tensile forces transferred through the line to the end caps and shroud bodies and ultimately to the frangible connecting rivets. At a predetermined tensile force, the frangible connectors break and thereby separate the first end cap and receptacle shroud body from the second end cap and nozzle shroud body. When disconnected, the urging force of springs 110 would then move the individual poppet members, and particularly poppet seals 104, into engagement with associated valve seats 114. In this manner, the fuel line disposed upstream of shroud body 42 is closed by the upstream poppet and, likewise, the fuel line disposed downstream of the nozzle shroud body 70 is shutoff by its associated poppet. Any fuel spill is limited in amount, and the remainder of the fuel line assembly would remain intact. In addition, the nozzle and mating receptacle at the vehicle would not be adversely impacted because of this breakaway disconnect feature. Moreover, the fuel delivery system would likewise be spared significant damage as a result of the frangible connection provided by the dry break disconnect. This will include not only the immediate fuel line effected by a driveaway event, but also associated fuel lines, whether they be the same or a different fuel such as provided on a gantry system.

A tubular sleeve or shroud 140 is preferably be incorporated into the disconnect assembly. The sleeve is connected to one of the shroud bodies, shown here as the nozzle shroud body, by suitable fasteners 142. If the frangible rivets are sheared during a driveaway event, the sleeve is then removed, the upstream and downstream components of the disconnect assembly re-assembled with new frangible connectors, and the sleeve then secured in place. Thus, it is contemplated that a majority of the components of the dry break disconnect assembly can be repeatedly used even if a disconnect resulting from a driveaway event occurs. Alternatively, if additional damage is encountered, it is contemplated that these components can be easily and effectively replaced during reassembly of the dry break disconnect assembly.

It is also contemplated that the dry break disconnect assembly may be secured to a frame, floor, etc. For example, the dry break disconnect assembly can be connected via a thin wire or the like to a floor to provide some predetermined slack in the filling line. If a driveaway event occurs during fueling, the tensile forces imposed on the fuel line are further limited upstream of the disconnect. That is, the additional securing to the floor may limit forces transferred to an upstream portion of the fuel line from the disconnect until the frangible connecting rivets are sheared.

It is contemplated that the majority of the components of the dry break disconnect assembly are formed from a suitable material that is compatible with the fuel and temperature requirements of the system such as a stainless steel, while seal portions may likewise be formed of a suitable seal material, particularly such materials that are not adversely impacted by the temperatures or particular fuels being dispensed therethrough. In the assembled position shown in FIG. 4, fuel upstream of the disconnect assembly passes around the upstream poppet, passes around the downstream poppet and exits via a downstream fuel line to the nozzle without any significant impact on desired fuel filling flow rates.

The invention has been described with reference to a preferred embodiment. Obviously, modifications and alterations will occur to others upon a reading and understanding of this specification. It is intended to include such modifications and alterations insofar as they come within the scope of the present claims or the equivalents thereof.

Having thus described the invention, it is now claimed:

1. A dry break disconnect assembly for use in an associated fuel delivery system having a flexible fuel line extending from a fuel reservoir adapted for selective connection with an associated vehicle to be filled with fuel, the dry break disconnect assembly comprising:
a first member having a first shutoff member received therein;
a second member having a second shutoff member received therein;
means for establishing flow through the shutoff members when the first and second members are connected together; and
a frangible connection securing the first and second members together so that the frangible connection breaks under a predetermined load and the first and second shutoff members are actuated to shutoff positions in response to the predetermined load.

2. The invention of claim 1 wherein the frangible connection includes a series of spaced pins interconnecting the first and second members.

3. The invention of claim 2 wherein the pins are circumferentially spaced about the first and second members.

4. The invention of claim 1 wherein each of the first and second shutoff members is a valve urged by a biasing member toward a closed position when the first and second members are separated.

5. The invention of claim 4 wherein each shutoff valve includes a stem extending axially therefrom for selective operative engagement with the stem from the other shutoff valve and overcome the force of the biasing member when the first and second members are secured together.

6. The invention of claim 1 further comprising a hollow sleeve extending over the frangible connection.

7. A fuel delivery system comprising:
a fuel line extending from an associated fuel reservoir and adapted for selective connection with an associated vehicle to be filled with fuel;
a first member having a first shutoff valve received therein;
a second member having a second shutoff valve received therein, the shutoff valves selectively movable to a flow position when the first and second members are connected together and establishing flow therethrough; and
means for connecting the first and second members together so that the connecting means separates under a driveaway event, and the first and second shutoff valves move to shutoff positions in response thereto.

8. The invention of claim 7 wherein the connecting means includes plural frangible members interconnecting the first and second members, the frangible members designed to break in response to a predetermined load imposed during the driveaway event.

9. The invention of claim 7 wherein the connecting means includes plural, spaced frangible members interconnecting the first and second members.

10. The invention of claim 9 wherein the plural frangible members are disposed circumferentially about the first and second members.

11. The invention of claim 10 wherein the plural frangible members extend in a generally radial direction.

12. The invention of claim 9 wherein the plural frangible members extend in a generally radial direction.

13. The invention of claim 7 further comprising a securing member for attaching the first and second members in a slack condition.

14. A method of disconnecting a fuel line during a driveaway event comprising the steps of:
incorporating a drybreak disconnect into a fuel line;
mounting at least one frangible connector in the drybreak disconnect; and
providing first and second shutoff valves on opposite ends of the disconnect assembly to shut off flow therethrough in the event of a driveaway event.

15. The method of claim 14 comprising the further step of securing the fluid line at the drybreak disconnect in a slack position.

16. The method of claim 15 wherein the securing step includes securing the fluid line to a stationary structure.
